(19) United States
(12) Patent Application Publication
(10) Pub. No.: US 2009/0052501 A1
(43) Pub. Date: Feb. 26, 2009

(54) VOICE COMMUNICATION APPARATUS

(75) Inventor: Shigeo Sato, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: UNIDEN CORPORATION, Tokyo (JP)

(21) Appl. No.: 11/843,849

(22) Filed: Aug. 23, 2007

(51) Int. Cl. H04B 1/707

(52) U.S. Cl. 375/145; 375/E01.002

(57) ABSTRACT

A voice communication apparatus includes a primary modulator configured to perform primary modulation of a carrier with a center frequency outside a voice band by an analog voice signal; a PN-code generator configured to convert data into a PN code; an adder configured to add data included in the voice band and the primary-modulated voice signal; and a secondary modulator configured to perform secondary modulation of the PN code included in the voice band and the primary-modulated voice signal. According to the voice communication apparatus, an analog voice signal can be directly spread.

### BACKGROUND OF THE INVENTION

1. Field of the Invention

The present invention relates to voice communication apparatuses for directly spreading analog voice signals.

2. Description of the Related Art

TDMA (time division multiple access)/TDD (time division duplex) is the mainstream of wireless access in digital cordless telephones. TDMA/TDD employs TDMA as a wireless access scheme and TDD as a transmission scheme. TDMA/TDD has an advantage in that, by digitizing voice signals, a plurality of voice signals and data can be multiplexed in one frequency channel.

A system using a digital communication scheme requires digitization of voice signals. Besides the problem of degradation of the original sound quality of an analog signal, digitization involves an increase in the cost.

An analog communication scheme represented by FM (frequency modulation) or the like can implement frequency spread communication by performing frequency hopping of a carrier frequency. However, the operation of a slave station for following a master station becomes complex, and, inconveniently, the system configuration becomes as complex as a digital communication system using the frequency hopping scheme.

### SUMMARY OF THE INVENTION

Known spread spectrum schemes in digital communication include frequency hopping and direct spread spectrum. However, no proposal has been made yet for a communication scheme of directly spreading analog voice signals in indoor wireless communication systems represented by telephones.

It is an object of the present invention to provide a voice communication apparatus configured to directly spread an analog voice signal.

It is another object of the present invention to provide a voice communication apparatus with a superior anti-interception function.

It is yet another object of the present invention to provide a voice communication apparatus capable of simultaneously transmitting/receiving a voice signal and control data using an analog communication scheme.

In order to achieve the foregoing objects, a voice communication apparatus according to an aspect of the present invention performs primary modulation of a carrier with a center frequency outside a voice band by an analog voice signal to move the analog voice signal outside the voice band. The voice communication apparatus includes data in the voice band, which has become available due to the primary modulation, and performs secondary modulation of the data included in the voice band and the primary-modulated voice signal. It is preferable that the data included in the voice band be converted into a PN (pseudo-noise) code.

### BRIEF DESCRIPTION OF THE DRAWINGS

FIG. 1 is a block diagram of a transmission system of a voice communication apparatus according to an embodiment of the present invention; and

FIG. 2 is a block diagram of a reception system of the voice communication apparatus according to the embodiment.

### DESCRIPTION OF THE PREFERRED EMBODIMENTS

Exemplary embodiments of the present invention will now herein be described with reference to the drawings.

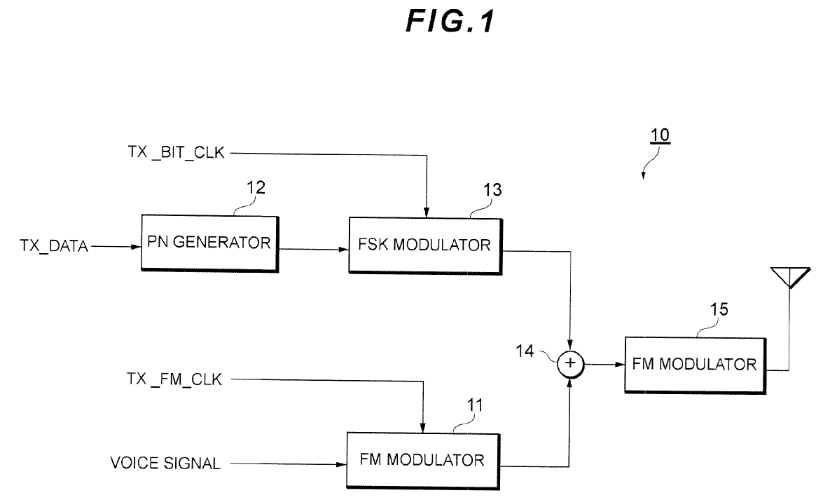

FIG. 1 illustrates a transmission system of a voice communication apparatus according to an embodiment of the present invention.

A transmission system 10 includes an FM modulator 11, a PN-code generator 12, a FSK (frequency-shift keying) modulator 13, an adder 14, and an FM modulator 15. Referring to FIG. 1, TX_FM_CLK indicates a carrier for performing primary modulation of an analog voice signal and has a center frequency outside a voice band (e.g., 100 kHz); TX_BIT_CLK indicates a carrier for performing FSK modulation of data (control data other than voice signals); and TX_DATA indicates a data stream transmitted from a controller such as a central processing unit (CPU) (not shown).

The FM modulator 11 performs FM modulation of the carrier TX_FM_CLX by an analog voice signal, thereby moving the analog voice signal to a frequency outside a voice frequency band. In this specification, modulation for moving an analog voice signal outside the voice band is referred to as primary modulation. Primary modulation can be implemented not only by FM modulation, but also by AM (amplitude modulation).

With primary modulation performed, the voice band becomes empty. The transmission system 10 uses this empty voice band to transmit data. Data for transmission through the voice band is preferably converted into a PN code before transmission in order to prevent the data from being intercepted. For example, in the case of no transmission data, a transmission bit is fixed to “0” or “1”. This indicates a direct current, and hence no signal exists in the voice band. In this case, a voice signal can be intercepted by, for example, a general measuring device or a wireless line monitor. Such interception can be avoided by converting transmission data into a PN code.

The PN-code generator 12 converts the data stream TX_DATA into PN codes. Preferably, a plurality of types of PN codes is used. For example, in the case where two types of PN codes, PN1 and PN2, is used, PN1 is assigned to transmission data “1”, and PN2 is assigned to transmission data “0”. Accordingly, PN2-PN1-PN1-PN2 is assigned to transmission data “0110”. In the case of no transmission data, PN 1 may be transmitted. By using a plurality of types of PN codes, the anti-interception performance becomes more robust.

Since PN codes used here are not required to achieve spread spectrum gain for their purpose, the number of bits is not particularly limited. It is preferable that PN codes have superior auto-correlation characteristics. In the case where a plurality of types of PN codes is used, as has been described above, it is preferable that the correlation characteristics between the PN codes be superior as well.

The FSK modulator 13 performs FSK modulation of the carrier TX_BIT_CLK by the PN codes. The carrier TX_BIT_CLK is preferably a signal with a center frequency within the voice band. For example, a sine wave, a square wave, a triangular wave can be used. In particular, a triangular wave is preferable. By using a triangular wave, the frequency spectrum of the voice band can be adjusted thoroughly and uniformly.

The FSK modulator 13 is not essential and may be omitted. Instead of the FSK modulator 13, a waveform-shaping filter may be used. The waveform-shaping filter is configured to separate an analog voice signal existing outside the voice band from data existing within the voice band so that the analog voice signal and the data are prevented from existing in the same frequency band.

The analog voice signal existing outside the voice band and the data existing within the voice band are added by the adder 14, and the sum is FM-modulated by the FM modulator 15. In order to distinguish modulation performed by the FM modulator 15 from primary modulation, this modulation performed by the FM modulator 15 is referred to as secondary modulation in this specification. Secondary modulation can be implemented not only by FM modulation, but also by AM modulation.

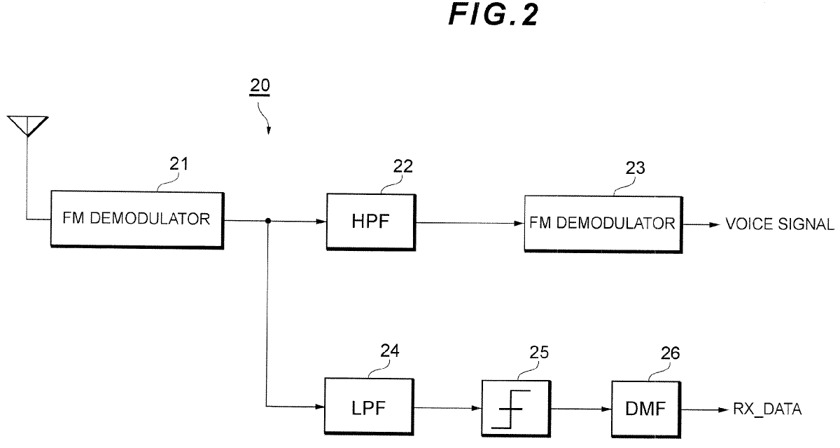

FIG. 2 illustrates a reception system of the voice communication apparatus according to the embodiment.

A reception system 20 includes an FM demodulator 21, a high-pass filter 22, an FM demodulator 23, a low-pass filter 24, a determining unit 25, and a digital matched filter 26.

A radio signal (secondary-modulated radio signal) transmitted from the transmission system 10 is demodulated by the FM demodulator 21 back to a primary-modulated signal. Of the primary-modulated signal, high-frequency components (voice signal components moved to frequencies higher than the voice band) pass through the high-pass filter 22, demodulated by the FM demodulator 23, and output as a voice signal.

In contrast, low-frequency components (data included in the voice band) of the primary-modulated signal pass through the low-pass filter 24, and the data is determined by the determining unit 25 whether the data is “0” or “1”. Thereafter, the digital matched filter 26 outputs reproduced data RX_DATA.

According to the embodiment as has been described above, an analog voice signal can be directly spread without being digitized.

Also, a safe communication system with an enhanced anti-interception function can be provided by converting transmission data into PN codes.

An analog voice signal and data can be simultaneously transmitted by moving the analog voice signal outside a voice band and including data in the voice band.

Further, the frequency spectrum within the voice band can be adjusted uniformly by performing FSK modulation of PN codes by the FSK modulator 13.

What is claimed is:

1. A voice communication apparatus comprising:
a primary modulator configured to perform primary modulation of a carrier with a center frequency outside a voice band by an analog voice signal; and
an adder configured to add data included in the voice band and the primary-modulated voice signal.

2. The voice communication apparatus according to claim 1, further comprising a secondary modulator configured to perform secondary modulation of the data included in the voice band and the primary-modulated voice signal.

3. The voice communication apparatus according to claim 1, wherein the data is control data other than a voice signal.

4. The voice communication apparatus according to claim 1, further comprising a pseudo-noise-code generator configured to convert the data into a pseudo-noise code.

5. The voice communication apparatus according to claim 1, further comprising a modulator configured to modulate a carrier with a center frequency within the voice band by the data.

6. The voice communication apparatus according to claim 5, wherein the carrier is one of a sine wave, a square wave, and a triangular wave.
